(19) United States
(12) Patent Application Publication
(10) Pub. No.: US 2013/0203028 A1
(43) Pub. Date: Aug. 8, 2013

(54) COORDINATION AND CONTROL TEST DEVICE

(71) Applicant: COSKUNOZ HOLDING ANONIM SIRKETI, BURSA (TR)

(72) Inventors: REMZI SULO, BURSA (TR); GULCER AYDIN, BURSA (TR)

(73) Assignee: COSKUNOZ HOLDING ANONIM SIRKETI, BURSA (TR)

(21) Appl. No.: 13/834,102

(22) Filed: Mar. 15, 2013

(30) Foreign Application Priority Data
Oct. 7, 2010 (TR) 2010/08234
Oct. 3, 2011 (EP) PCT/EP2011/067214

(51) Int. Cl. G09B 5/00

(52) U.S. Cl. CPC G09B 5/00
USPC 434/236; 434/258

(57) ABSTRACT

A device measuring the control of the individual on the hand and eye coordination and the control of the individual on the hand and arm muscles during the response the individual gives after he/she senses the stimulus visually, in the area of measurement and evaluation of the psychomotor and cognitive processes.

### CROSS-REFERENCE TO RELATED APPLICATION

This is a Continuation application of PCT Patent Application PCT/EP2011/067214 filed on Oct. 3, 2011, which claims the priority benefit of Turkish Patent Application Serial No. 2010/08234, filed Oct. 4, 2010, which is hereby incorporated herein by reference.

### TECHNICAL FIELD

The present invention relates to a test device measuring the control of the individual on the hand and eye coordination and the control of the individual on the hand and arm muscles during the response the individual gives after he/she senses the stimulus visually, in the area of measurement and evaluation of the psychomotor and cognitive processes.

### BACKGROUND

Industrial and Organizational Psychology is a psychology science which was applied in the industrial plants in the past and which is applied today in pluralities of foundations. When Industrial and Organizational Psychology is examined, it is observed that Industrial and Organizational Psychology has two basic structures. The first of these structures is the harmonization of the individual to the work and the other is the harmonization of the work to the individual. The harmonization of the individual to the work comprises the steps of personnel selection, personnel training and the professional help; on the other hand, the harmonization of the work to the individual comprises the processes of task design, the arrangement of the tools according to the individual, and shaping the working conditions according to the physical and psychological structure of the individual.

In the area of Industrial and Organizational Psychology, pluralities of measurement and evaluation tools are used for the selection of the suitable personnel. Psycho-technical evaluation can be defined as the measurement of the physical, psychomotor and cognitive abilities and the personal characteristics of an individual by means of pluralities of tests which are linguistic or non-linguistic. In the area of Industrial and Organizational Psychology, in personnel selection, in other words, in the selection of the suitable applicant to the suitable position, psycho-technical evaluation is used. The physical power (like the muscle power, body power), psychomotor (like coordination ability, response speed) and cognitive abilities (like judgment, visual and auditory attention and speed distance forecast) and the personal abilities (like willingness to take risks, anxiety level) are measured and the best applicant is selected in terms of the abilities the task requires.

Pluralities of studies for the measurement of psychomotor abilities are realized and some techniques are determined. In the patent application US5344324, a test device is disclosed which provides the computer-aided measurement of the abilities of the employees working as operator. Said test device provides testing of the attention judgment abilities of the operators and besides it provides testing of the psychomotor abilities of the operators. As a result of this test, the work loss is desired to be calculated which results from the operators and which can occur during operation. Another patent application is the application WO9529447, where psycho-technical evaluation is used and which is applied in a different field. Said patent relates to a test device designed to be used in health sector. Said test device is used for completely or at least partially curing the patients who are suffering from attention deficit.

As a result, a test device is not observed in the abovementioned patent applications, which measures the control of the individual on the hand and eye coordination and the control of the individual on the hand and arm muscles during the response the individual gives after he/she senses the stimulus.

### SUMMARY OF THE INVENTION

The present invention is a test device which measures the psychomotor abilities, that brings new advantages to the relevant technical field.

The main object of the invention is to provide the measurement of the coordination between the eye and the hand, during the sensing of the individuals the visual stimulus and during the response they give.

Another object of the invention is to provide the measurement of the control of the individuals on the hand and arm muscles.

Another object of the invention is to provide the measurement of the marking sensitivity on the stimulus, during the marking of the stimulus as a response of the individuals to the stimulus.

Another object of the invention is to determine if the individual is suitable for the related position or not according to the result of the test applied or to direct the individual to a suitable position.

In the light of the above mentioned objects and the objects obtained from the detailed description, the present invention relates to a test device measuring the control of the individual on the hand and eye coordination and the control of the individual on the hand and arm muscles during the response the individual gives after he/she senses the stimulus visually, in the area of measurement and evaluation of the psychomotor and cognitive processes. In order to realize this object, the device comprises the following members:
a. An operating system,
b. At least one input unit with a key pad thereon, in order to provide the data entry to the operating system,
c. One image source which is related to the operating system, which has at least one painting line therein which are different from each other, which has at least one geometrical figure and which has at least one image,
d. At least one data source which is related to the operating system, which has the data therein which is entered by means of the input unit and which has the test data to be applied,
e. At least one record unit which is related to the operating system, which keeps the answers given by the individuals during the test,
f. At least one screen which is related to the operating system, which displays said painting lines, geometric figures and images,
g. A painting gun which is related to the operating system, in order to determine the response given by the individuals to the painting lines, geometric figures and image during test,
h. At least one timer which is related to the operating system, which measures the beginning, finishing and process duration for each process on the screen during test steps,
i. A processor unit which is related to the operating system, which provides the displaying of said painting lines, geometric figures and image on the screen at a predetermined arrangement, which provides the recording of the responses of the individuals like the release duration of the trigger, the instantaneous position of the circle exiting from the painting gun, the trigger pushing and trigger releasing instants to the record unit, and which functions together with said timer.

In another preferred embodiment of the invention, the responses of the individuals which are mentioned in item (i) and which are recorded by the record unit are as follows; the beginning and finishing time of the test, the release number of the painting gun, overflow amount from the painting lines and from geometrical figures, the completion duration of the painting lines and image total marking, the amount of empty space inside the image.

In another preferred embodiment of the invention, according to the predetermined arrangement in said item (i); first of all, the first painting line appears on the screen, afterwards, the system waits for the individual for the marking process, afterwards, the second painting line appears on the screen and these steps are repeated for the other third and fourth painting lines, the first and the second geometrical figures and finally the image appear on the screen.

In another preferred embodiment of the invention, there is at least one compiling unit which is related to the operating system and which classifies the data recorded by the record unit.

In another preferred embodiment of the invention, there is an analysis unit which is related to the operating system and which provides the comparison of the files recorded by the record unit.

In another preferred embodiment of the invention, there is at least one pointer whose diameters are different from each other, and which provides the adjustment of the diameters of the laser rays which are related to the end part of said painting gun.

In another preferred embodiment of the invention, there is at least one ear phone which provides the transferring of the voiced instructions to the individuals during the test.

In another preferred embodiment of the invention, said operating system is a computer.

In another preferred embodiment of the invention, said input unit is a keyboard.

In another preferred embodiment of the invention, said image source, data source and record unit are hard disks.

In another preferred embodiment of the invention, there is a platform whereon all of the abovementioned members are placed at a predetermined arrangement and on which the individuals to whom the test is applied are standing.

In another preferred embodiment of the invention, there are pluralities of tables which are positioned around the platform and which determine the platform borders, in order for the individuals not to go beyond the area determined inside the platform.

In another preferred embodiment of the invention, said painting lines are routes which have beginning and ending points.

In another preferred embodiment of the invention, the difference between the first painting line, second painting line, third painting line and fourth painting line is that the return curves thereof on the painting lines are different.

In another preferred embodiment of the invention, the difference between the first geometrical figure and the second geometrical figure is the diameter difference.

In another preferred embodiment of the invention, said geometrical figures are circles.

A test method measuring the control of the individual on the hand and eye coordination and the control of the individual on the hand and arm muscles during the response the individual gives after he/she senses the stimulus visually, characterized by comprising the steps of:
a. Recording of the individual to the operating system by himself/herself,
b. Starting the test from the data source in the direction of the predetermined timings in relation to the processor unit timer,
c. Displaying of the first painting line on the screen by the operating system,
d. Waiting the first painting line on the screen until the individual finishes the first painting line marking process,
e. Recording the individual's marking duration by the record unit,
f. Displaying of the second painting line on the screen by the operating system,
g. Waiting the first painting line on the screen until the individual finishes the second painting line marking process,
h. Recording the individual's response duration by the record unit.
   Said test method also comprises the process steps of:
i. Displaying of the third and the fourth painting lines on the screen one after the other at a predetermined sequence,
j. Recording of the durations of the responses by the record unit which the individual gives to the third and fourth painting lines,

Said test method also comprises the following steps:
k. Displaying of the first geometrical figure on the screen by the operating system,
l. The individual realizes marking by means of the painting gun until the first geometrical figure disappears from the screen,
m. Recording the individual's response by the record unit,
n. Displaying of the second geometrical figure on the screen by the operating system,
o. The individual realizes marking by means of the painting gun until the second geometrical figure disappears from the screen,
p. Recording the individual's response by the record unit.
   Said test method also comprises the following steps:
q. Displaying of the image on the screen by the operating system,
r. The individual paints inside of the image on the screen until the white area inside the image finishes,
s. Recording the individual's response by the record unit.
t. Ending of the test.

For the embodiment of the present invention and to understand the advantages with the additional elements in the best way possible, the invention should be used with the figures and the detailed explanation that are explained below.

### BRIEF DESCRIPTION OF THE FIGURES

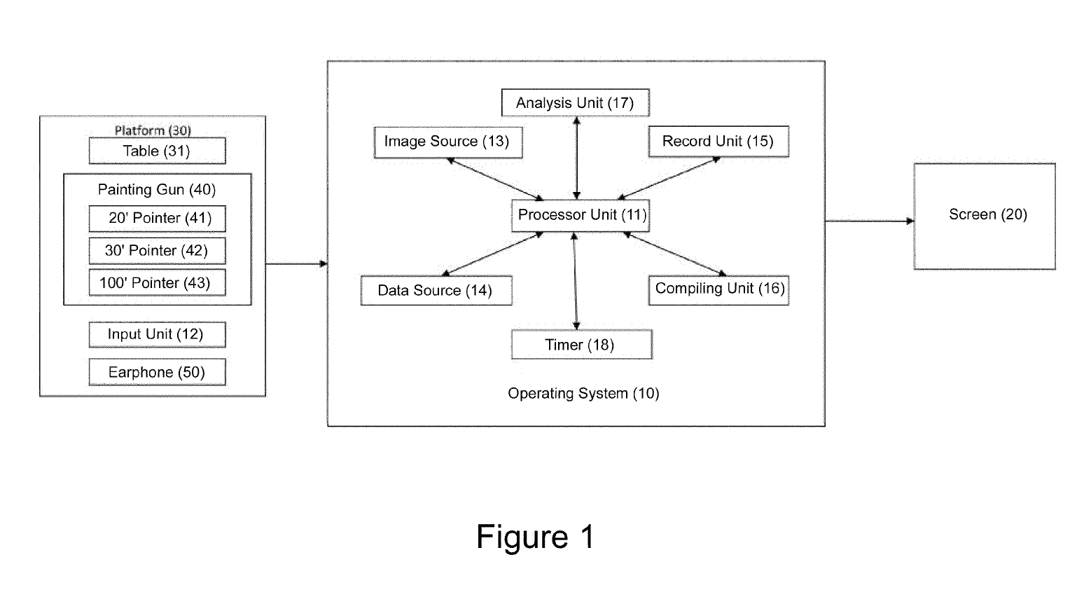

In FIG. 1, the schematic view of the device is given.

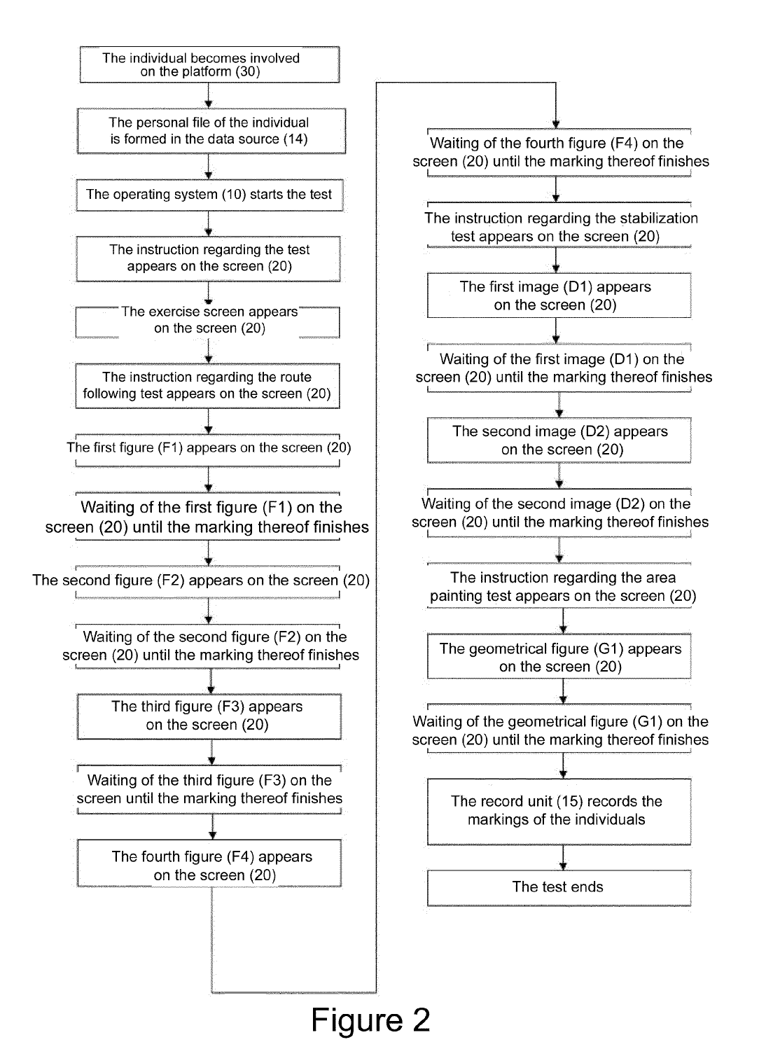

In FIG. 2, the flow schema of the test is given.

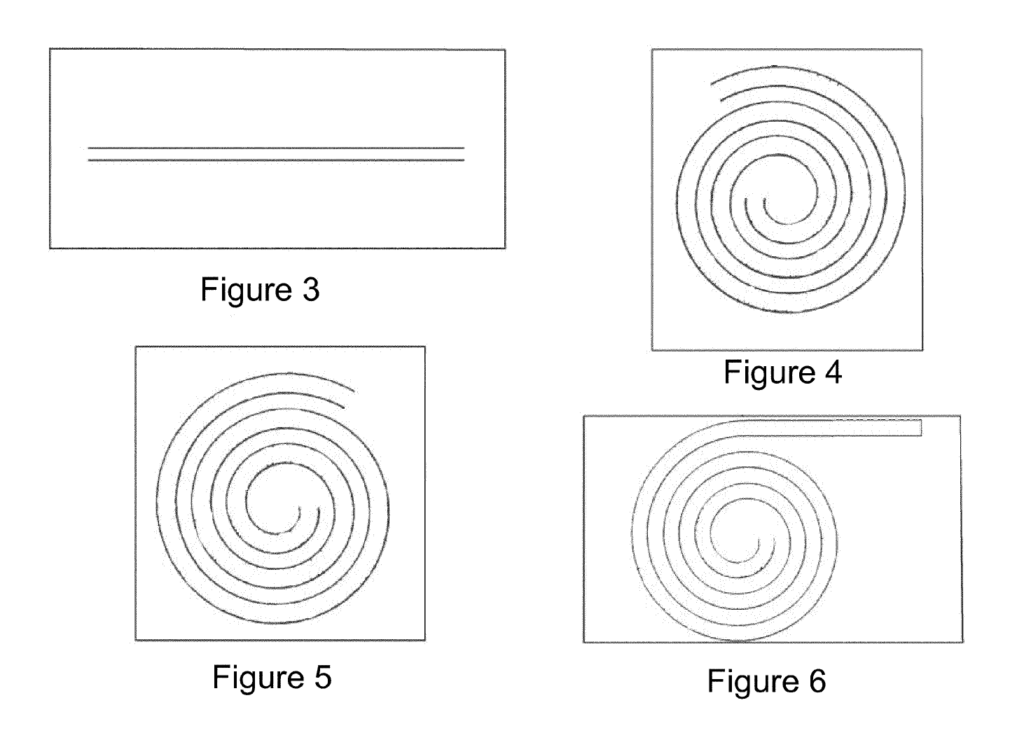

In FIG. 3, the representative view of the first painting line is given.

In FIG. 4, the representative view of the second painting line is given.

In FIG. 5, the representative view of the third painting line is given.

In FIG. 6, the representative view of the fourth painting line is given.

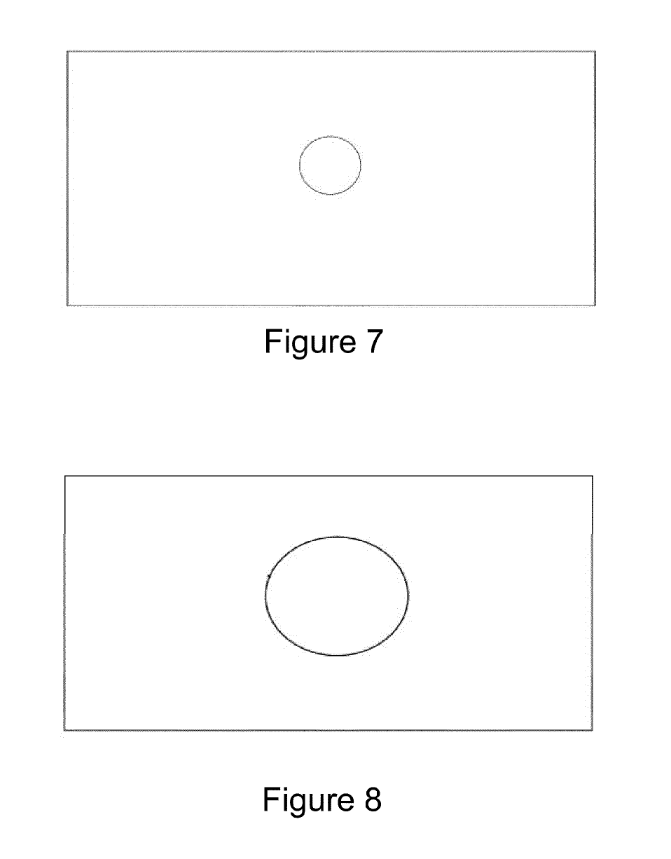

In FIG. 7, the representative view of the first geometrical figure on the screen is given.

In FIG. 8, the representative view of the second geometrical figure on the screen is given.

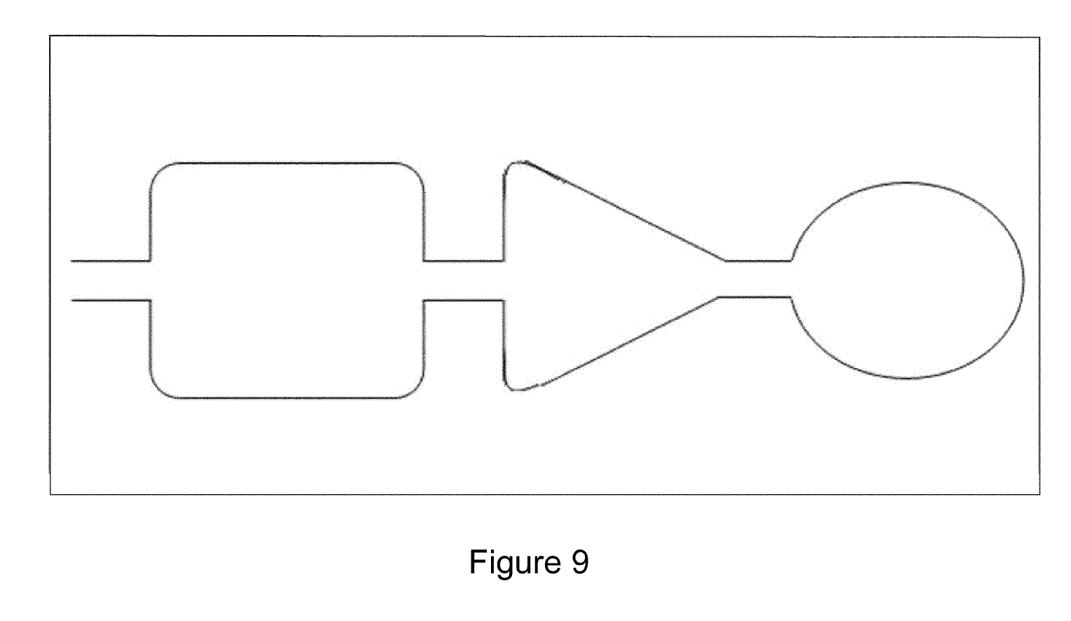

In FIG. 9, the representative view of the image is given.

### DETAILED DESCRIPTION OF THE INVENTION

In this detailed explanation, the invented subject matter system is explained with examples in order to make the subject more understandable without forming any restrictive effect. Accordingly, in the detailed description below and in the figures, the subject matter invention relates to a test device measuring the control of the individual on the hand and eye coordination and the control of the individual on the hand and arm muscles during the response the individual gives after he/she senses the stimulus visually, in the area of measurement and evaluation of the psychomotor and cognitive processes.

As can be seen in FIG. 1, the schematic view of the subject matter device is given. The device essentially comprises an operating system (10); a screen (20) which visually illustrates the data related to the operating system (10); a platform (30) where the individual is subject to test; a painting gun (40); and an earphone (50).

The operating system (10) has a structure similar to a computer frame, it has housings or slots (not illustrated in the figure) to which the other members can be connected. Moreover, around the slots for protecting said members, there are structures similar to protective plate (not illustrated in the figure). There is an input unit (12) which is related to the operating system (10) and whereon the key pad is placed. There is an image source (13), a data source (14), a record unit (15), a compiling unit (16), an analysis unit (17) and a timer (18), related to said slots inside the operating system (10). Moreover, there is a processor unit (11) which is positioned inside the operating system (10).

There are tables (31) which are prepared in the same dimensions and which are positioned around the platform (30). Said tables (31) provide the individuals to stay inside the predetermined area borders on the platform (30). Another object of the tables (31) is that the painting gun (40) and ear phone (50) used during the test can be left on the table (31) after the test. Said painting gun (40) has a form similar to a gun and it has an end part (not illustrated in the figure) similar to a gun barrel through which the laser rays will exit and said painting gun (40) has a trigger mechanism (not illustrated in the figure) positioned thereon. There is 20′ pointer (41), 30′ pointer (42) and 100′ pointer (43), related to the end part through which the laser rays of said painting gun (40) exit. When the trigger mechanism existing on the painting gun (40) is pressed, a laser ray is produced so as to be seen on the screen (20). Said pointers (41, 42, 43) provide the laser rays exiting from the painting gun to be at the desired width.

The operation of the members existing inside the operating system (10) is as follows. By means of the keys on said input unit (12), data input can be realized to the operating system (10). Said data can be the personal data of the individuals who are subject to test, they provide the realization of all of the data input like the connections and relations between the members related to the test. The data whose input process is realized is kept and stored in the data source (14). The stored data can be viewed again and they can be used again and when required, changes can be realized thereon. The image source (13) embodies the data which is to be used visually. The data existing inside the data source (14) and the visual data existing inside the image source (13) become related and the connections between the data are provided. The record unit (15) records the personal information of the individuals subject to the test and it records the answers of the individuals during the test. Thanks to this, it keeps the information of the numerical data like how many situations an individual faces in the personal data file during test, how the individual responses to the situation he/she faces, how long the response the individual gives takes. The compiling unit (16) provides the classification of the information said record unit (15) records when there is more than one individual. When the information of the individuals who are tested in this manner is desired to be accessed, the access is facilitated in the frame of a certain classification. The analysis unit (17) provides the comparison of the test results of more than one individual. The analysis unit (17) numerically analyses the test results of the selected people when the test results recorded by the record unit (15) is desired to be compared and the analysis unit (17) provides the advantages and disadvantages between the individuals to be taken into consideration. The analysis unit (17) provides the sequencing of the results in addition to the comparison process. The processor unit (11) has the task of matching the data buses between the members. The timer (18) has the task of measuring the durations predetermined for the test; measuring the passage duration between the cases; and measuring the time difference between the time when the individuals face the stimulus and the time when they give response to the stimulus. The timer (18) functions together with the processor unit (11).

On the screen (20), the data coming from the operating system (10) is transformed into visual form. The image source (13) embodies the visual members in three different groups with respect to the steps of the test to be applied. In general, said groups comprise four painting lines (F1, F2, F3, F4) in order to be used in the first step of the test, two geometrical figures (D1, D2) in order to be used in the second step of the test, and an image (G1) in order to be used in the final step of the test. The first painting line (F1) which is one of the painting lines (F1, F2, F3, F4) which are to be used in the first step of the test is a flat line with a certain width and the other painting lines (F2, F3, F4) comprise lines with the same width and with pluralities of curves. The geometrical figures (D1, D2) to be used in the second step comprise two circles whose diameters are different from each other. The image (G1) to be used in the third step of the test is an image where four geometrical figures similar to circle, triangle, rectangle and square exist together.

The operation of the test device is as follows. The personal information of the individual subject to the test is recorded in the record unit (15) by means of the input unit (12). The individual, who takes the place thereof inside the platform (30) borders, takes the ear phone (50) and the painting gun (40) hardware from the table (31). On the screen (20), the rules, which are to be obeyed during the test, appear by means of writings and figures on a light grey background. On these writings and figures, the information like how the painting gun will be used and like how the individual has to stand is mentioned in detail, moreover, this information is given to the individual by means of the ear phone (50) of the individual simultaneously. After the required information is given to the individual, in order for the individual to get used to the painting gun (40), an exercising screen appears on the screen (20), which is a blank black page. On this page, the individual realizes exercises for one minute. After the exercise duration is completed, on the screen (20), the instructions appear which are related to the route following test which is the first step of the test. In the route following test, the individuals are requested to mark the painting lines (F1, F2, F3, F4) appearing on the screen (20), inside the width borders from the circle figure in the beginning point of the painting lines (F1, F2, F3, F4) until the circle figure at the ending point by means of the painting gun (40). During this process, the individuals are requested to not to release the trigger on the painting gun (40) as much as possible. On the screen (20), the first painting line (F1) appears on the black background. The first painting line (F1) is a flat route. When the painting gun (40) is activated, the individual presses the trigger and he/she starts painting inside the first painting line (F1), which is black, by white color. When the 20′ pointer (41), which is fixed onto the painting gun (40), comes onto the circle figure in the ending point, the painting gun is deactivated, and 3 seconds later, the second painting line (F2) appears on the screen (20). When the second painting line (F2) appears on the screen (20), by beginning from the beginning circle in a similar manner to the first painting line (F1), the route in the second painting line (F2) is painted white, and marking is realized until the circle point at the end. The other second, third and fourth painting lines (F2, F3, F4) except the first painting line (F1) have curved form. When each painting line (F1, F2, F3, F4) is marked with the help of the painting gun (40), the next painting line (F1, F2, F3, F4) appears on the screen (20). After the marking of the fourth painting line (F4) finishes, on the screen (20), the instruction regarding the next test appears.

After the route following test finishes, on the screen (20), the instructions regarding the stabilization test appear. In the stabilization test, the individuals are requested to aim at the geometrical figure in the middle of the screen (20) by means of the painting gun (40) and they are requested to fix the painting gun (40) on that geometrical figure for a certain duration. There are two of said geometrical figures and the first geometrical figure (D1) is a white circle with a width of 40 units and the second geometrical figure (D2) is a white circle with a width of 120 units. During this test, together with the painting gun (40), 30′ pointer (42) and 100′ pointer (43) are used respectively. On the next screen (20), in the middle of the screen (20), the first geometrical figure (D1) appears, and on the painting gun (40), by means of the 30′ pointer (42), by pressing on the trigger of the painting gun (40), the individual waits on the geometrical figure. Meanwhile, on the screen (20), the writing appears which tells the individual to continue pressing on the trigger. The individual continues to press on the trigger until the color of the first geometrical figure (D1) turns to black again. After the first geometrical figure (D1) disappears from the screen, the 30′ pointer (42) at the end part of the painting gun is removed and the 100′ pointer (43) is fixed. In the middle of the screen (20), the second geometrical figure (D2) appears. In the second geometrical figure (D2), as in the first geometrical figure (D1), the individual aims the painting gun (40) on the second geometrical figure (D2) and presses the trigger. The individual continues pressing on the trigger until the second geometrical figure (D2) becomes black and until it disappears from the screen (20). After the second geometrical figure (D2) disappears from the screen (20), the second step of the test finishes and the test passes to the painting test which is the third step.

At the beginning of the area painting test, on the screen (20), the instructions regarding the area painting step appear. In this step, the individuals are requested to completely paint inside the image (G1) appearing on the screen (20), with the help of the painting gun (40). After the image (G1) appearing on the screen (20) and he/she is requested to realize the painting process until the inside of the image (G1) turns black completely. After the individual paints the inside of the image (G1) completely black, he/she comes to the ok button existing on the lower right corner of the screen (20) and he/she presses on the trigger of the painting gun (40) and he/she finishes the test. After the third step of the test is finished, the test is finished completely.

During the test, the behaviors of the individuals during the test are recorded by the record unit (15). For each step, the data which is recorded is as follows. For the route following test, the beginning and finishing times of the individuals for each painting line (F1, F2, F3, F4). The painting duration of the painting line (F1, F2, F3, F4), the releasing number of the trigger, the number of exits from the painting line (F1, F2, F3, F4) and the amount of exits from the painting line (F1, F2, F3, F4). For the stabilization test, for each geometrical figure (D1, D2), the instants of pressing and releasing the trigger, the number of releases of the trigger, the number of deflections from the target point and the amount of the deflections from the target point. For the area painting test, from the instant the area inside the image (G1) is started to be painted until the marking of the finishing point, the number of releases of the trigger, the painting duration, the empty space inside the image (G1), and the amount of overflow from the image (G1) are recorded.

The protection scope of the present invention is set forth in the annexed Claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. A test device measuring the control of the individual on the hand and eye coordination and the control of the individual on the hand and arm muscles during the response the individual gives after he/she senses the stimulus visually in the area of measurement and evaluation of the psychomotor and cognitive processes. In order to realize this object, the device comprises the following members:
an operating system,
at least one input unit with a key pad thereon, in order to provide the data entry to the operating system,
an image source which is related to the operating system, which has at least one painting line therein which are different from each other, which has at least one geometrical figure and which has at least one image,
at least one data source which is related to the operating system, which has the data therein which is entered by means of the input unit and which has the test data to be applied,
at least one record unit which is related to the operating system, which keeps the answers given by the individuals during the test,
at least one screen which is related to the operating system, which displays said painting lines, geometric figures and images,
a painting gun which is related to the operating system, in order to determine the response given by the individuals to the painting lines, geometric figures and image during test,
at least one timer which is related to the operating system, which measures the beginning, finishing and process duration for each process on the screen during test steps, and
a processor unit which is related to the operating system, which provides the displaying of said painting lines, geometric figures and image on the screen at a predetermined arrangement, which provides the recording of the responses of the individuals like the release duration of the trigger, the instantaneous position of the circle exiting from the painting gun, the painting gun trigger pushing and the painting gun trigger releasing instants to the record unit, and which functions together with said timer.

2. A test device according to claim 1, characterized in that the responses of the individuals which are recorded by the record unit are as follows; the beginning and finishing time of the test, the release number of the painting gun, overflow amount from the painting lines and from geometrical figures, the completion duration of the painting lines and image total marking, the amount of empty space inside the image.

3. A device according to claim 1, characterized in that, according to the predetermined arrangement; the first painting line appears on the screen, afterwards, the system waits for the individual for the marking process, afterwards, the second painting line appears on the screen and these steps are repeated for the other third and fourth painting lines, the first and the second geometrical figures and finally the image appear on the screen.

4. A test device according to claim 1, characterized in that, at least one compiling unit is provided which is related to the operating system and which classifies the data recorded by the record unit.

5. A test device according to claim 1, characterized in that an analysis unit is provided which is related to the operating system and which provides the comparison of the files recorded by the record unit.

6. A test device according to claim 1, characterized in that at least one pointer is provided whose diameters are different from each other, and which provides the adjustment of the diameters of the laser rays which are related to the end part of said painting gun.

7. A device according to claim 1, characterized in that said operating system is a computer, said input unit is a keyboard and said image source, data source and record unit are hard disks.

8. A test device according to claim 1, characterized in that a platform is provided whereon all members are placed at a predetermined arrangement and on which the individuals to whom the test is applied are standing.

9. A test device according to claim 8, characterized in that a plurality of tables are provided which are positioned around the platform and which determine the platform borders, in order for the individuals not to go beyond the area determined inside the platform.

10. A test device according to claim 1, characterized in that said painting lines are routes which have beginning and ending points.

11. A test device according to claim 10, characterized in that the difference between the first painting line, second painting line, third painting line and fourth painting line is that the return curves thereof on the painting lines are different.

12. A test device according to claim 1, characterized in that the difference between the first geometrical figure and the second geometrical figure is the diameter difference.

13. A test method measuring the control of the individual on the hand and eye coordination and the control of the individual on the hand and arm muscles during the response the individual gives after he/she senses the stimulus visually, characterized by comprising the steps of:
recording of the individual to the operating system by himself/herself,
starting the test from the data source in the direction of the predetermined timings in relation to the processor unit timer,
displaying of the first painting line on the screen by the operating system,
waiting the first painting line on the screen until the individual finishes the first painting line marking process,
recording the individual's marking duration by the record unit,
displaying of the second painting line on the screen by the operating system,
waiting the first painting line on the screen until the individual finishes the second painting line marking process, and
recording the individual's response duration by the record unit.

14. A test method according to claim 13, characterized by comprising the process steps of:
displaying of the third and the fourth painting lines on the screen one after the other at a predetermined sequence, and
recording of the durations of the responses by the record unit which the individual gives to the third and fourth painting lines.

15. A test method according to claim 13, characterized by comprising the process steps of:
displaying of the first geometrical figure on the screen by the operating system,
the individual realizes marking by means of the painting gun until the first geometrical figure disappears from the screen,
recording the individual's response by the record unit,
displaying of the second geometrical figure on the screen by the operating system,
the individual realizes marking by means of the painting gun until the second geometrical figure disappears from the screen, and
recording the individual's response by the record unit.

16. A test method according to claim 13, characterized by comprising the test steps of:
displaying of the image on the screen by the operating system,
the individual paints inside of the image on the screen until the white area inside the image finishes,
recording the individual's response by the record unit, and ending of the test.

17. A test method according to claim 13, characterized in that the responses of the individuals recorded by the record unit are as follows; the pressing and release instant of the trigger of the painting gun, the instantaneous position of the circle exiting from the painting gun, the trigger releasing durations of the painting gun, the beginning and ending duration of the test, the number of releases of the painting gun, overflow amount from the painting lines and geometrical figures, the completion duration of the painting lines and image total marking, the amount of empty space inside the image.

18. A test method according to claim 13, characterized in that said operating system is a computer and said record unit is a hard disk.

19. A test method according to claim 13, characterized in that the difference between the first line, second line, third line and fourth line is that the return curves thereof on the painting lines are different.

20. A test method according to claim 13, characterized in that the difference between the first and the second geometrical figures is the diameter difference.
